(19) United States
(12) Patent Application Publication
(10) Pub. No.: US 2006/0024650 A1
(43) Pub. Date: Feb. 2, 2006

(54) Kinesiology-based self-improvement process

(76) Inventor: Gerald N. Epstein, New York, NY (US)

Correspondence Address: FERENCE & ASSOCIATES, 409 BROAD STREET, PITTSBURGH, PA, 15143, US

(21) Appl. No.: 10/903,920

(22) Filed: Jul. 30, 2004

(51) Int. Cl. G09B 19/00

(52) U.S. Cl. 434/236

(57) ABSTRACT

The promotion of self-improvement through a combination of mental imagery and beliefs. More particularly, a combination of mental imagery, beliefs and kinesiology is broadly contemplated. It is contemplated that, on a personal level, acts addressing such concepts could occupy hardly more than about a minute of an individual's time in a given day.

### FIELD OF THE INVENTION

The present invention relates generally to the field of self-improvement and self-help, especially in connection with psychological constructs intended to assist in the same.

### BACKGROUND OF THE INVENTION

The general field of self-improvement and self-help has long been ripe for systems and arrangements that allow individuals to approach various tasks and challenges ever more efficiently. As such, psychological considerations often come to mind when developing such systems.

Various isolated concepts in this realm have accorded some measure of benefit, such as “mental imagery”, “beliefs” and “kinesiology”. “Mental imagery” is normally defined as the mind “thinking in pictures”, or a “natural language” of “inner life”. It is also described as a three-dimensional form occurring in the inner forum of consciousness having no volume or mass, yet perceptible to our consciousness. “Image” can also be defined as the form inwardly given to a “belief” (see below).

The second concept mentioned above, “belief”, tends to be common to a wide range of systems of thought and is a common term synonymous with conviction and certainty as well as doctrine, view, or ideas. Essentially, beliefs shape and guide our life direction, attitudes, behavior. They can be defined more precisely as inner ideas or thoughts, or maintained systems of inner thinking, feeling, or sensation that are understood to shape our everyday experiences. When a belief is manifested inwardly in a form that is made more tangibly recognizable and understood, one may refer to such an inner form as an “image”.

The third concept mentioned above, “kinesiology”, was introduced to the U.S. within the past several decades as a way of muscle testing to determine the efficacy and/or potency of various substances such as: medication, vitamins, minerals and other items. It subscribes to a chief principle that when an item is “not good for us”, major muscles in the body become weak in that connection and can scarcely resist even a slight touch despite one's inclination to consciously resist. Kinesiology is thus normally defined as a science dealing with the interrelationship of the physiological processes and anatomy of the human body with respect to movement.

As stated above, though in isolation each of these three concepts might accord some benefits, a need has still been recognized in connection with providing even more efficient systems and arrangements for self-help and self-improvement.

### SUMMARY OF THE INVENTION

In accordance with at least one presently preferred embodiment of the present invention, there is broadly contemplated, a concept of promoting self-improvement through the combination of mental imagery and beliefs. More particularly, a combination of the three aforementioned concepts (mental imagery, beliefs and kinesiology) is broadly contemplated. It is contemplated that, on a personal level, acts addressing such concepts could occupy hardly more than about a minute of an individual's time in a given day.

In summary, one aspect of the invention provides a process for promoting holistic self-improvement, the process comprising: establishing a first setpoint based on a negative construction; conducting a first physical test associated with the first setpoint; establishing a second setpoint based on a positive construction; conducting a second physical test associated with the second setpoint; and verifying that the second physical test yields a more favorable result than the first physical test.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a flowchart illustrating various steps of a self-improvement process.

### DESCRIPTION OF THE PREFERRED EMBODIMENTS

In accordance with at least one presently preferred embodiment of the present invention, an individual seeking self-help or self-improvement (hereafter referred to as “the patient”) is encouraged to think about a belief that is most troubling at a given moment. For instance, one may be in a position to lament over “never being able to meet a guy”. To remedy this, it is encouraged for the patient to manifest an associated mental act; in this example, one may conceive of a mental picture of a stereotypical (or caricatured) “old lady spinster”. It is then encouraged for the patient to consciously think about an opposite belief and an opposite mental image. In the present example, the opposite belief might be, “I am meeting a guy” and an opposite mental image might be that of a soon to be married couple walking down the aisle.

Generally, the implementation of a five-step process is broadly contemplated in accordance with at least one embodiment of the present invention. By following this five-step process, it is believed that positive changes in the patient's may be brought about virtually instantaneously. The constituent elements of this process draw on the three general concepts mentioned heretofore (mental imagery, beliefs and kinesiology) to beget a much more effective and comprehensive process.

Accordingly, it should be appreciated that the aforementioned three general concepts touch on three distinct spheres whose unification is much greater than the sum of the constituent parts. In this connection, two areas can be said to relate to the mind (mental imagery and beliefs) with the third relating to the body (kinesiology).

In this regard, it can be aptly recognized that when individuals harbor in mind “positive'”, i.e., beneficial and constructive, beliefs and images, various muscles can and do become stronger. It can also be recognized that the opposite would hold true in the presence of “negative” beliefs and images. Such weakening of the muscles will thus provide tangible evidence of a compromised anatomical/physiological condition.

Perhaps this phenomenon can convincingly be demonstrated in the arm, where the muscles are normally very strong. By way of kinesiological testing, an individual could be asked to stretch out one arm straight, away from the body, and to flex its muscles to make the arm strong. Then, when the individual (the patient) harbors positive images and beliefs, it becomes very difficult for another individual to push one the patient's arm downward (e.g., by pushing down on the patient's wrist). Conversely, when the patient harbors negative images and beliefs, it becomes comparatively very easy for another individual to push the arm down in response to an analogous force (as in the “positive” scenario just mentioned).

Therefore, it is recognized that if a patient shifts or changes any images and/or beliefs that he/she harbors from “negative” to “positive” then the muscles will respond accordingly and become effectively strengthened. In this connection, it is contemplated, in accordance with at least one presently preferred embodiment of the present invention, that this significant shift be promoted at least twice a day (such as upon waking and before bed) for a period of up to 21 days.

The result, it is found, is that astounding changes inure to the benefit of the patient in a wide variety of spheres (e.g., physically, emotionally, mentally, socially, financially, etc.) The process, it will be appreciated, is very simple to implement and carry out, requiring hardly one minute in the aggregate of a patient's time commitment per day. With such simple repetition of a relatively simple and convenient exercise, it can become habitual over the predetermined period and thus exceedingly easy to integrate into one's daily schedule.

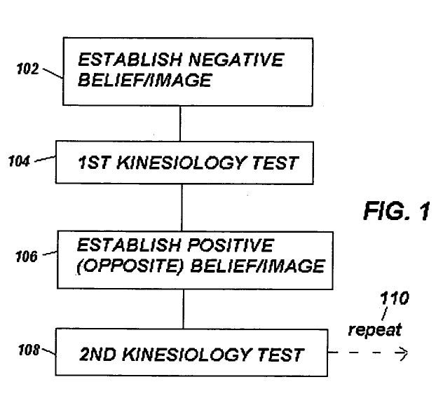

Accordingly, there is broadly contemplated in accordance with at least one presently preferred embodiment of the present invention a five-step process incorporating mental imagery, belief systems, and kinesiology as an integrated program directed towards self-help and self-improvement (which itself can have the ancillary effect of benefiting others in a wider social community). With reference to FIG. 1, the five steps can be summed up as:

1. Establish the belief system that one wants to change. (102)

2. Carry out a kinesiology test to show how the troubling belief is adversely affecting the body. (104)

3. Change the belief by visualizing an image of the opposite, trouble-free, state of mind. (106)

4. Carry out the kinesiology test again to show how the body has now strengthened (and thus inured holistically to the benefit of one's “entire person”). (108)

5. Repeat the process at least two times per day for a predetermined number of days (up to 21) (110).

As far as kinesiology tests are concerned, a one-person test (i.e., self-test) and multi-person (e.g., two-person) tests are possible. For instance, the arm test discussed heretofore (where arm strength is tested via an individual's arm being pushed downward) can be readily carried out with two people, namely, the patient and an individual who pushes the patient's arm downwards during the testing. A wide variety of self-tests are of course contemplated. In one, the patient can make an O-ring with the thumb and middle finger, then take the thumb and middle finger of the other hand and make an interlocking O-ring. Thence, the patient will try to pull (i.e., force) the second O-ring through the first O-ring, particularly where the fingers of the first O-ring join. Weakness is indicated by an ease of pulling the second O-ring through the first, while strength is indicated by great resistance towards doing so. In another self-test, essentially the same thing is contemplated but one hand uses a thumb-and-pinky O-ring combination to ensure less resistance in one manner or another. With the thumb and forefinger of the opposite hand, one attempts to push open the O-ring using the pressure of the thumb and forefinger. If strong, the thumb and forefinger cannot be pushed open. It should be appreciated, in general, that a very wide variety of kinesiology tests (self-tests and otherwise), as presently known, may very readily be utilized in accordance with the embodiments of the present invention.

Again, it is recognized that the individual steps 1-4 outlined above need only take a fraction of a minute each, with the result that less than one minute per day in the aggregate would need to be spent. Twenty one days appears to represent a highly favorable time frame in which to carry out steps 1-4, preferably at three times a day. Benefits are also apparent in shorter time frames, however, such as 14-20 days or 7-13 days.

Throughout the day, great benefit can also be derived by reconstructing the “positive” image or belief at times when the “negative” image or belief is prone to be bothersome. In this manner, the “negative” thought or belief can be used as a reminder, or trigger, for the patient to transform the same into the “positive” thought or belief.

The process described heretofore has indeed been found to provide great benefit to patients implementing the same. As such, it may also be recommended for a patient to keep track of positive changes that do accrue during the predetermined number of days in which the process will be implemented (e.g., by making notations in a notebook).

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A process for promoting holistic self-improvement, said process comprising:
establishing a first setpoint based on a negative construction;
conducting a first physical test associated with the first setpoint;
establishing a second setpoint based on a positive construction;
conducting a second physical test associated with the second setpoint; and
verifying that the second physical test yields a more favorable result than the first physical test.

2. The process according to claim 1, wherein said steps of establishing a first setpoint, conducting a first physical test, establishing a second setpoint, conducting a second physical test and verifying are repeated at least two more times in the same day.

3. The process according to claim 1, wherein said steps of establishing a first setpoint, conducting a first physical test, establishing a second setpoint, conducting a second physical test and verifying are performed at least twice a day for a predetermined number of days.

4. The process according to claim 3, wherein said steps of establishing a first setpoint, conducting a first physical test, establishing a second setpoint, conducting a second physical test and verifying are performed three times a day for a predetermined number of days.

5. The process according to claim 3, wherein the predetermined number of days is greater than or equal to 7.

6. The process according to claim 5, wherein the predetermined number of days is greater than or equal to 14.

7. The process according to claim 6, wherein the predetermined number of days is 21.

8. The process according to claim 1, wherein the first and second physical tests are kinesiology tests.

9. The process according to claim 8, wherein said verifying step comprises verifying that the second physical test indicates increased physical strength in comparison with the first physical test.

10. The process according to claim 1, wherein the first setpoint is based on at least one negative belief or mental image.

11. The process according to claim 1, wherein the second setpoint is based on at least one positive belief or mental image.

12. The process according to claim 1, wherein the positive construction is essentially the opposite of the negative construction.
